(19) United States
(12) Patent Application Publication
(10) Pub. No.: US 2018/0371922 A1
(43) Pub. Date: Dec. 27, 2018

(54) COMPOSITE TURBOMACHINE COMPONENT AND RELATED METHODS OF MANUFACTURE AND REPAIR

(71) Applicant: General Electric Company, Schenectady, NY (US)

(72) Inventors: Wojciech Filip SITKIEWICZ, Warsaw (PL); Artur Marcin CHUC-KARMANSKI, Warsaw (PL); Magdalena GACA, Grudziadz (PL); Adam GAIK, Warsaw (PL); Piotr Artur KLIMCZUK, Warsaw (PL); Michal KOWALCZYK, Baranow (PL); Robert Tomasz LISKIEWICZ, Warsaw (PL); Mariusz PAKUSZEWSKI, Warsaw (PL); Stephen Paul WASSYNGER, Simpsonville, SC (US); Marek WOJCIECHOWSKI, Warsaw (PL)

(21) Appl. No.: 15/979,498

(22) Filed: May 15, 2018

(30) Foreign Application Priority Data
Jun. 21, 2017 (EP) 17461553.4

(51) Int. Cl. F01D 5/28; F01D 5/22

(52) U.S. Cl. CPC F01D 5/28; F01D 5/225; F05D 2300/603; F05D 2300/50212; F05D 2300/175; F05D 2260/83; F05D 2230/237; F05D 2240/30; F05D 2240/80; F05D 2260/81; F05D 2260/941

(57) ABSTRACT

Various aspects include a composite turbomachine component and related methods. In some cases, a method includes: identifying a location of potential or actual structural weakness in a body of a turbomachine component, the body including a first material having a first thermal expansion coefficient; forming a slot in the location of the body, the slot extending at least partially through a wall of the turbomachine component; and bonding an insert to the body at the slot to form a composite component, the insert including a second material having a second thermal expansion coefficient differing from the first thermal expansion coefficient by up to approximately ten percent, the second material consisting of a nickel-chromium-molybdenum alloy, wherein after the bonding the insert is configured to reduce the potential or actual structural weakness in the body.

### FIELD OF THE INVENTION

The subject matter disclosed herein relates to manufacturing and repair of components. More specifically, the subject matter disclosed herein relates to approaches of manufacturing and/or repairing components to manage material stress.

### BACKGROUND OF THE INVENTION

During operation, turbomachine components, such as turbomachine blades and nozzles, are subjected to high temperatures, pressures and/or stresses over extended periods. In many cases, particular portions of these components can be subject to differential stresses due to their geometry and location relative to a working fluid (e.g., gas or steam). For example, a blade platform or tip, or a nozzle sidewall, can be subject to different warmup and cool down rates than the airfoil of that same blade or nozzle. This differential thermal inertia can cause tensile stress at or near the platform and/or tip (or sidewall). These tensile stresses may contribute to cracking or other material fatigue, and ultimately can require repair and/or maintenance.

### BRIEF DESCRIPTION OF THE INVENTION

Various aspects of the disclosure include a composite turbomachine component and methods of forming such a component. In a first aspect, a method includes: identifying a location of potential or actual structural weakness in a body of a turbomachine component, the body including a first material having a first thermal expansion coefficient; forming a slot in the location of the body, the slot extending at least partially through a wall of the turbomachine component; and bonding an insert to the body at the slot to form a composite component, the insert including a second material having a second thermal expansion coefficient, the second thermal expansion coefficient differing from the first thermal expansion coefficient by up to approximately ten percent, the second material consisting of a nickel-chrome-molybdenum alloy, wherein after the bonding the insert is configured to reduce the potential or actual structural weakness in the body.

A second aspect of the disclosure includes a composite turbomachine component having: a body including: a wall; and a slot extending at least partially through the wall, wherein the body includes a first material having a first thermal expansion coefficient, the first material including at least one of: steel, at least one nickel-chromium superalloy, at least one cobalt-based superalloy or at least one nickel-based superalloy; an insert substantially filling the slot, the insert including a second material having a second thermal expansion coefficient, the second thermal expansion differing from the first thermal expansion coefficient by up to approximately ten percent, the second material consisting of a nickel-chromium-molybdenum alloy; and a weld or braze joint coupling the insert to the body at the slot.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic depiction of a plurality of turbomachine components.

FIG. 2 is a schematic depiction of the plurality of turbomachine components of FIG. 1, further illustrating a process of identifying a location of potential or actual structural weakness in the component(s) according to various embodiments of the disclosure.

FIG. 3 is a schematic close-up depiction of a portion of one of the turbomachine components from FIG. 2, further illustrating a process according to various embodiments of the disclosure.

FIG. 4 is a schematic close-up depiction of the portion of the turbomachine component from FIG. 3, further illustrating a process according to various embodiments of the disclosure.

FIG. 5 is a flow diagram illustrating processes in forming a composite turbomachine component according to various embodiments of the disclosure.

FIG. 6 shows a block diagram of an additive manufacturing process including a non-transitory computer readable storage medium storing code representative of one or more portions of the composite component of FIG. 4 according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

The subject matter disclosed herein relates to manufacturing and/or repair. More specifically, the subject matter disclosed herein relates to composite components with materials of distinct thermal expansion coefficients, and methods of forming those components.

In contrast to conventional approaches, various aspects of the disclosure include a composite turbomachine component, and methods of forming such a component. In various embodiments, the composite turbomachine component has a body and an insert filling a slot in the body, where the location of the slot is determined based upon an expected or actual amount of material fatigue in that portion of the body. The insert can be welded to the body at the slot, but in some cases, the insert could also be brazed to the body at the slot. In various embodiments, the body of the turbomachine component is formed of steel or an alloy, such as at least one nickel-chromium superalloy, at least one cobalt-based superalloy or at least one nickel-based superalloy (e.g., Inconel-738, Inconel-939, Udimet 500 and Udimet 700, from Special Metals Corp., New Hartford, N.Y.; or GTD-111, GTD-222, GTD-241, GTD-741 or GTD-141 (from the General Electric Company, Boston, Mass.); or FSX-414). In various embodiments, the insert can include a material having a distinct thermal expansion coefficient from the material of the body, e.g., approximately 0.9 to approximately 1.1 times the thermal expansion coefficient of the body. In some cases, the insert can include a nickel-chromium-molybdenum alloy (e.g., Nimonic 263, from the Special Metals Corp or Haynes 230, from Haynes International, Inc., Kokomo, Ind.), and in some particular cases, the insert can consist substantially entirely (e.g., given nominal other materials) of a nickel-chromium-molybdenum alloy. The location of the slot (and insert) is determined based upon a model (e.g., a finite element analysis model) of the turbomachine component, or an observed wear on the turbomachine component (e.g., via human operator inspection, or with an optical inspection system, florescent inspection system, infra-red inspection system). The slot (and insert) may be located within a portion of the platform, in the case of a turbomachine blade, or a sidewall, in the case of a turbomachine nozzle. In some other cases, the slot (and insert) can be located proximate the tip of the airfoil, e.g., in a “Z-notch” region of the blade. The composite turbomachine component may be stronger than conventional turbomachine components formed of a uniform or substantially uniform material composition.

In some particular cases, the slot is machined from the body, e.g., by cutting, sanding or otherwise abraded the location in the body for the insert. After the insert is placed in the slot, it may be welded, brazed or otherwise heat-treated to bond with the body and fill the slot. After bonding the insert to the body at the slot, the surface of the insert and the body may be machined, e.g., grinded, sanded, or otherwise planarized to form a surface profile consistent with the original design of the blade.

In various embodiments, the composite component can include a refurbished component, e.g., where the body is an original part having gone through field use and the insert is a replacement portion of the component. In other cases, the composite component can include two original parts (either having gone through field use, or not) joined at an interface, and in other cases, the composite component can include two replacement parts joined at an interface.

In the following description, reference is made to the accompanying drawings that form a part thereof, and in which is shown by way of illustration specific embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely illustrative.

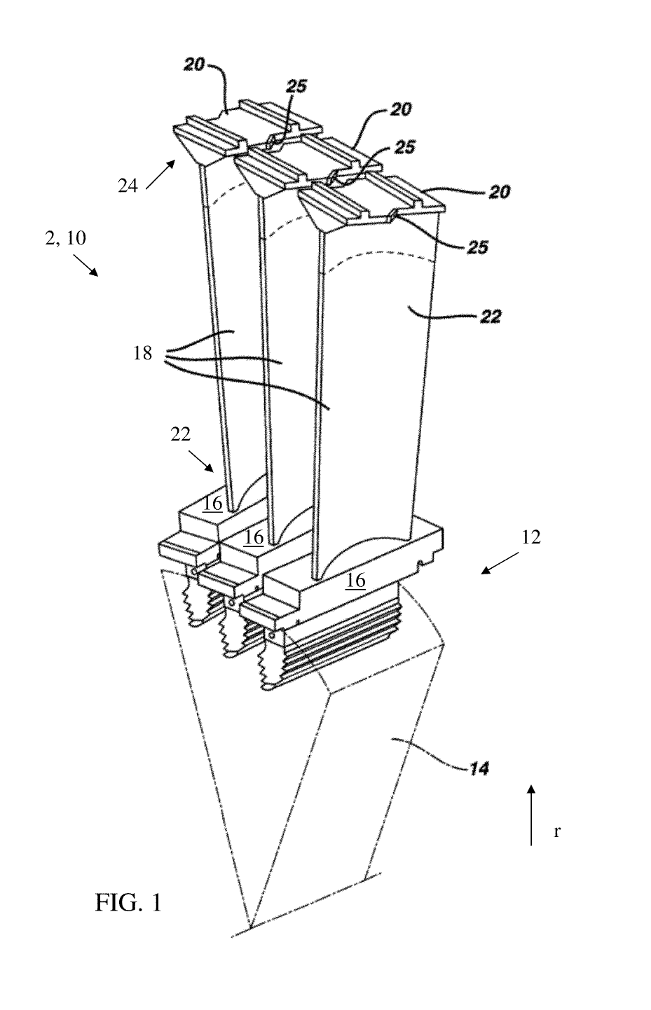

FIG. 1 shows an example set of turbomachine components 2. In some cases, turbomachine component 2 can include a gas turbomachine blade 10. However, as discussed herein, turbomachine component 2 can include turbine nozzles, guide vanes, etc., subject to high thermal stresses during operation. As shown, in some cases, a plurality of turbomachine components 2 (e.g., blades 10) can be coupled with a turbomachine disc 14 (rotor disc), forming part of a turbine stage 12. Each blade 10 can include a platform 16, an airfoil 18 connected with and radially extending from platform 16, and a shroud 20 connected airfoil 18. Platform 16 is coupled with base 22 of airfoil 18, and shroud 20 is coupled with tip 24 of airfoil 18. Adjacent shrouds 20 in a stage 12 can include complementary interfaces, also referred to as a Z-notch 25, for linking the blades 10 in the same stage 12.

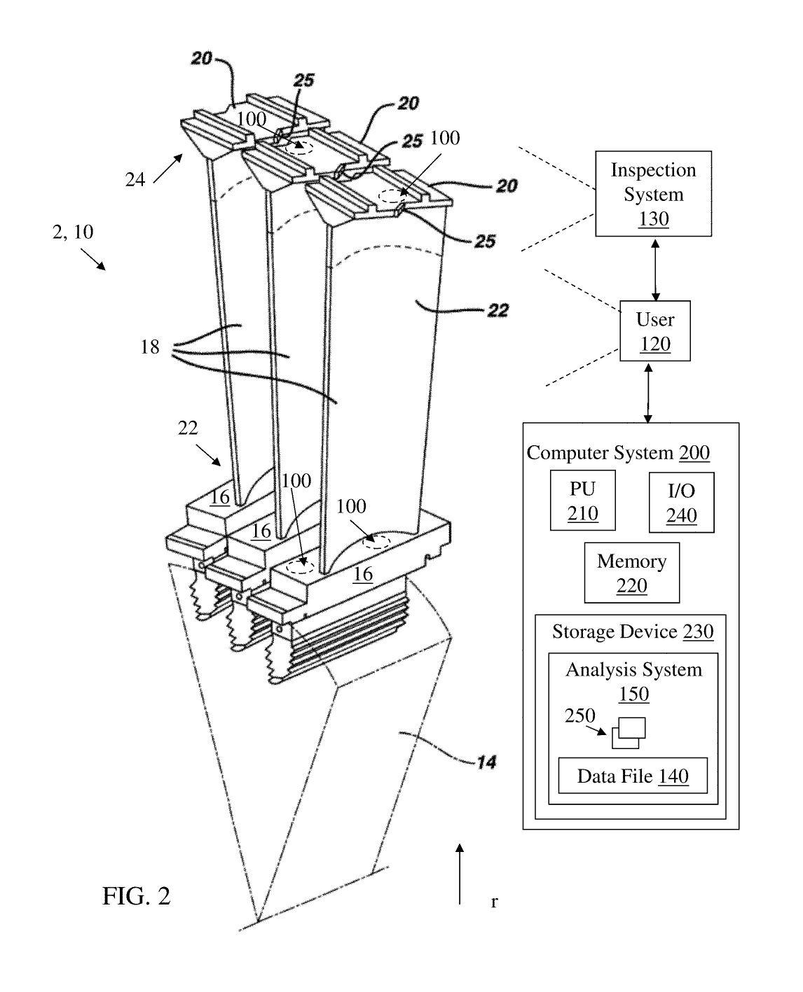

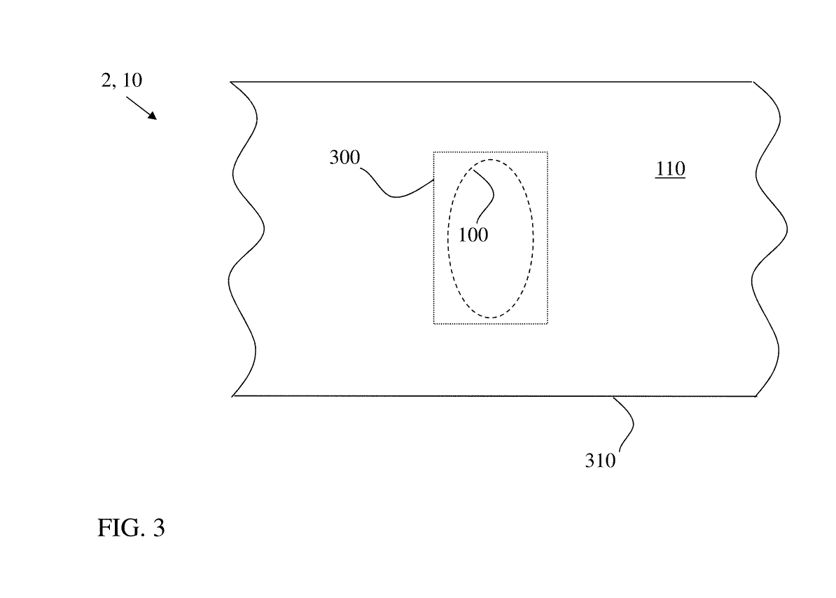

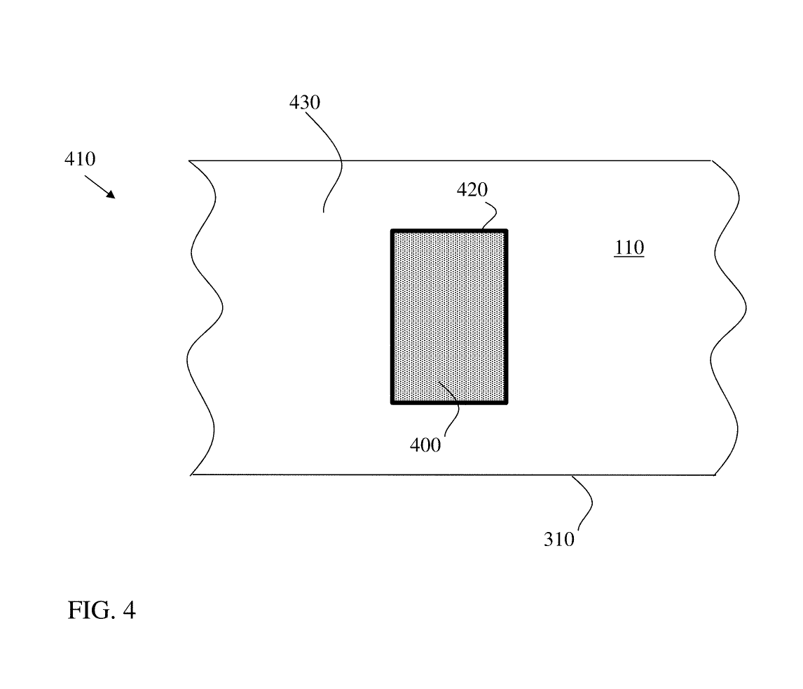

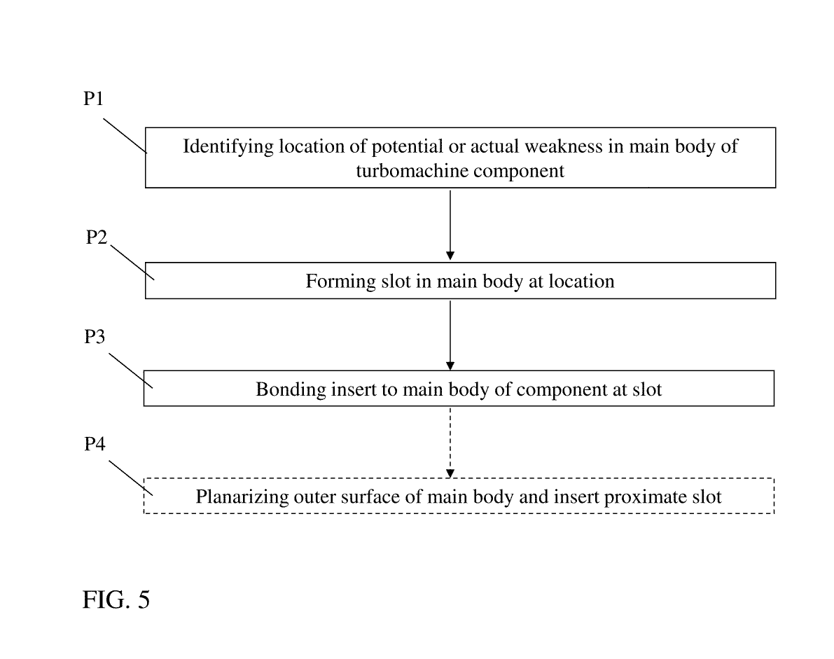

FIG. 2 illustrates a first process in a method of forming a composite turbomachine component according to various embodiments of the disclosure. FIGS. 3 and 4 show close-up schematic depictions of a portion of a turbomachine component 2 (such as blade 10, a nozzle, a guide vane, or other turbomachine component), undergoing additional processes in forming a composite turbomachine component 410 (FIG. 4) according to embodiments of the disclosure. FIG. 5 is a flow diagram illustrating processes shown and described with reference to FIGS. 2-4.

With reference to FIGS. 2-5, according to various embodiments, a method can include:

Process P1: identifying a location 100 of potential or actual structural weakness in a body 110 of turbomachine component 2. In various embodiments, body 110 includes a first material having a first thermal expansion coefficient. That is, in some cases, body 110 of component 2 is composed entirely, or approximately (e.g., within 1-3 percent) entirely of, a first material, which has a first thermal expansion coefficient. In some cases, the first material includes steel. It is understood that the first material or second material may include impurities to the extent acceptable in conventional turbomachine components. In some particular cases, the first material can include a steel or an alloy such as at least one nickel-chromium superalloy, at least one cobalt-based superalloy or at least one nickel-based superalloy (e.g., Inconel-738, Inconel-939, Udimet 500 and Udimet 700, from Special Metals Corp., New Hartford, N.Y.; or GTD-111, GTD-222, GTD-241, GTD-741 or GTD-141 (from the General Electric Company, Boston, Mass.); or FSX-414). In various embodiments, the thermal expansion coefficient of the first material (at an example temperature of approximately 815 degrees Celsius (1500 degrees Fahrenheit)) is approximately 8×10⁻⁵ in/(in F). The location 100 of potential or actual structural weakness in body 110 can be identified according to various embodiments. In some cases, location 100 can be identified by a user 120, e.g., a user such as a human user, robotic user or other machine. In some cases, user 120 can include, or work in conjunction with, an inspection system 130 for analyzing turbomachine component 2 to detect one or more location(s) 100 of potential or actual structural weakness. In some cases, inspection system 130 can include at least one of an optical scanner, an infrared scanner or a fluorescent inspection system. Inspection system 130 can include conventional scanning/inspection components such as laser-based detection components, infrared sensors, transmitters, receivers, transducers, etc. Where user 120 is a human user, that human user may visually inspect turbomachine component 2 to detect one or more location(s) 100 of potential or actual structural weakness. It is understood that user 120 and/or inspection system 130 may be particularly useful in detecting location(s) 100 of actual structural weakness, e.g., locations of visible or physically detectable cracks, deformations, material fatigue, etc. In some particular cases, a user 120 (e.g., human user) can use an inspection system 130, such as a fluorescent inspection system or a blue-light scanner to visually inspect component 2 to detect one or more locations 100 of structural weakness.

In some other embodiments, identifying location(s) 100 can include performing a finite element analysis on a data file 140 representing turbomachine component 2. In these embodiments, data file 140 can include a computer-aided design (CAD) file or other data model representing turbomachine component 2. In some cases, data file 140 can be used to form turbomachine component 2 or another similar component. In various embodiments, a turbomachine component analysis system (analysis system) 150 can be used to analyze data file 140 to identify location(s) 100 in turbomachine component 2 of potential or actual structural weakness. In particular cases, turbomachine analysis system 150 can be configured to identify locations(s) 100 of potential structural weakness in turbomachine component 2, e.g., based upon a modeled response of turbomachine component 2 to expected operating conditions such as particular temperature ranges, pressure ranges, fatigue cycles, warmup/cooldown cycles, etc. In various embodiments, turbomachine component analysis system 150 can be stored or otherwise deployed by a conventional computer system 200 having a processor (PU) 210, memory 220, storage device 230 and an input/output (I/O) device 240. Turbomachine component analysis system 150 can include one or more logic engines (or modules) 250 for executing commands to analyze data file 140 according to various embodiments described herein. In particular cases, data file 140 can include a three-dimensional (3D) model of the component 2, and analysis system 150 can include a software program for analyzing low-cycle fatigue and/or crack propagation in the 3D model, such as conventional simulation software (e.g., ANSYS Mechanical, from ANSYS, Inc., Canonsburg, Pa.).

According to various embodiments, where turbomachine component 2 includes a blade 10, location 100 may be within platform 16 or tip shroud 20, proximate airfoil 18. FIG. 2 illustrates several locations 100, within platform 16 and tip shroud 20, which shown in phantom to demonstrate that one or more locations 100 can be identified according to various embodiments. In some particular cases, location 100 can be proximate the aft (downstream) side of platform 16, for example, at the suction side of airfoil 18.

Process P2: after identifying location 100, according to various embodiments, the process can further include forming a slot 300 (FIG. 3) in location 100 of body 110, where slot 300 extends at least partially through a wall 310 of turbomachine component 2. In some cases, slot 300 can be formed by cutting turbomachine component 2 proximate location 100. In various embodiments, as shown in FIG. 3, slot 300 can be formed in an area substantially surrounding location 100 (e.g., at border of location 100 or slightly outside the border of location 100). In some embodiments, turbomachine component 2 can include an original equipment component not yet deployed in operation. In some particular cases, forming slot 300 in body 110 includes cutting or otherwise machining turbomachine component 2, e.g., with a saw or other machining tool. In other cases, turbomachine component 2 can be formed as an original component, including slot 300, via conventional molding, casting, etc., or via additive manufacturing techniques further described herein.

Process P3: after forming slot 300 in component 2, bonding an insert 400 (FIG. 4) to body 100 at the slot 300 to form a composite component 410. In various embodiments, insert 400 includes a second material (distinct from first material of body 100), having a second thermal expansion coefficient. The second thermal expansion coefficient can differ from the first thermal expansion coefficient by approximately +/−10 percent (e.g., approximately between 0.9-1.1 times the first thermal expansion coefficient of body 100 material). In some cases, insert can consist of, or substantially (e.g., 95% or greater) consist of the second material, which can include at least one nickel-chromium-molybdenum alloy (e.g., Nimonic 263, from the Special Metals Corp or Haynes 230, from Haynes International, Inc., Kokomo, Ind.), and in some particular cases, the insert can consist substantially entirely (e.g., given nominal other materials) of a nickel-chromium-molybdenum alloy. According to various embodiments, insert 400 is welded to body 110 at slot 300 according to conventional welding techniques. In some other cases, insert 400 is brazed to body 110 at slot 300 according to conventional welding techniques. In either case, insert 400 is bonded to body 110 with a weld or braze joint 420. In some cases, welding can be used to bond insert 400 to body 110 at slot, e.g., at a current of approximately 40-50 Amperes, with an arc voltage of approximately 10-15 volts. As noted herein, after bonding to body 110, insert 400 is configured to reduce the potential or actual structural weakness in body 110.

Process P4 (optional post-process): in some cases, after bonding insert 400 to body 110 of component 2, an additional process can include planarizing an outer surface 430 of body 110 and insert 400 proximate slot 300. In various embodiments, planarizing can include conventional machining processes such as sanding, grinding, polishing or otherwise smoothing outer surface 430 of body 110 and insert 400 proximate slot 300.

As shown in FIG. 4, processes P1-P3 (and optionally process P4), can be used to form composite turbomachine component 410 which is configured to reduce potential or actual structural weakness in a turbomachine component 2. That is, according to various embodiments, turbomachine component 410 is designed to include insert 400 at a strategically placed location 100 in order to reduce actual or potential structural weakness in the base turbomachine component 2.

It is understood that the processes described herein can be performed in any order, and that some processes may be omitted, without departing from the spirit of the disclosure described herein.

One or more portions of composite component 410 (FIG. 4) may be formed in a number of ways. In one embodiment, as noted herein, at least a portion of composite component 410 may be formed by conventional manufacturing techniques, such as molding, casting, machining (e.g., cutting), etc. In one embodiment, however, additive manufacturing is particularly suited for manufacturing at least a portion of composite component 410 (FIG. 4), e.g., turbomachine component 2 and/or insert 400. As used herein, additive manufacturing (AM) may include any process of producing an object through the successive layering of material rather than the removal of material, which is the case with conventional processes. Additive manufacturing can create complex geometries without the use of any sort of tools, molds or fixtures, and with little or no waste material. Instead of machining components from solid billets of metal (e.g., alloy) or other material such as plastics and/or polymers, much of which is cut away and discarded, the only material used in additive manufacturing is what is required to shape the part. Additive manufacturing processes may include but are not limited to: 3D printing, rapid prototyping (RP), direct digital manufacturing (DDM), selective laser melting (SLM) and direct metal laser melting (DMLM). In the current setting, DMLM can be beneficial.

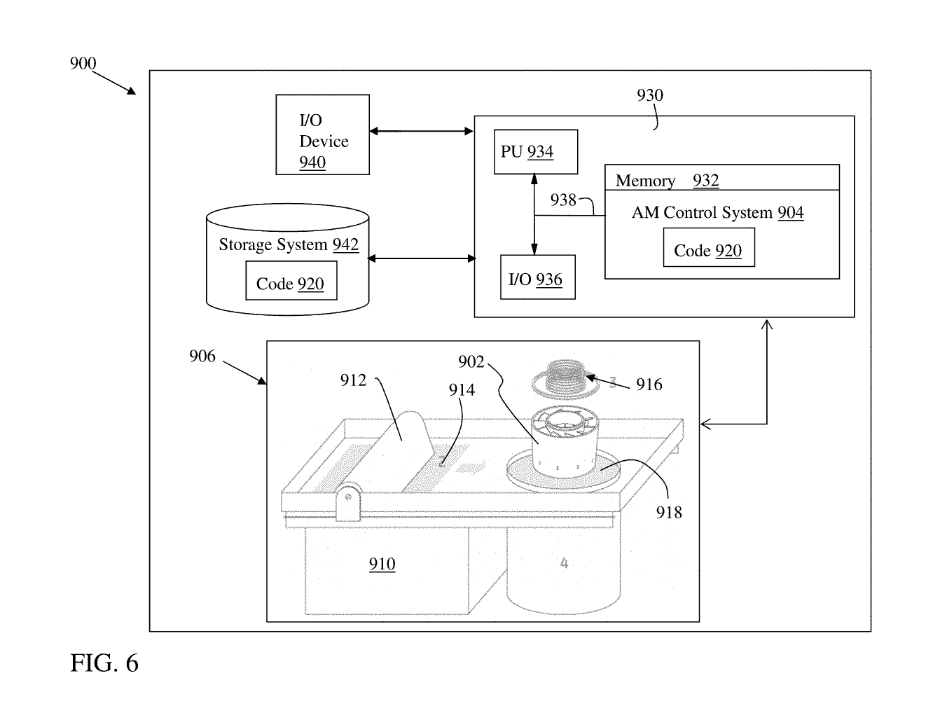

To illustrate an example of an additive manufacturing process, FIG. 6 shows a schematic/block view of an illustrative computerized additive manufacturing system 900 for generating an object 902. In this example, system 900 is arranged for DMLM. It is understood that the general teachings of the disclosure are equally applicable to other forms of additive manufacturing. Object 902 is illustrated as a double walled turbomachine component; however, it is understood that the additive manufacturing process can be readily adapted to manufacture at least a portion of composite component 410 (FIG. 4), e.g., turbomachine component 2 and/or insert 400. AM system 900 generally includes a computerized additive manufacturing (AM) control system 904 and an AM printer 906. AM system 900, as will be described, executes code 920 that includes a set of computer-executable instructions defining at least a portion of composite component 410 (FIG. 4) to physically generate the object using AM printer 906. Each AM process may use different raw materials in the form of, for example, fine-grain powder, liquid (e.g., polymers), sheet, etc., a stock of which may be held in a chamber 910 of AM printer 906. In the instant case, at least a portion of composite component 410 (FIG. 4) may be made of metal(s), alloy(s), plastic/polymers or similar materials. As illustrated, an applicator 912 may create a thin layer of raw material 914 spread out as the blank canvas from which each successive slice of the final object will be created. In other cases, applicator 912 may directly apply or print the next layer onto a previous layer as defined by code 920, e.g., where the material is a polymer. In the example shown, a laser or electron beam 916 fuses particles for each slice, as defined by code 920, but this may not be necessary where a quick setting liquid plastic/polymer is employed. Various parts of AM printer 906 may move to accommodate the addition of each new layer, e.g., a build platform 918 may lower and/or chamber 910 and/or applicator 912 may rise after each layer.

AM control system 904 is shown implemented on computer 930 as computer program code. To this extent, computer 930 is shown including a memory 932, a processor 934, an input/output (I/O) interface 936, and a bus 938. Further, computer 930 is shown in communication with an external I/O device/resource 940 and a storage system 942. In general, processor 934 executes computer program code, such as AM control system 904, that is stored in memory 932 and/or storage system 942 under instructions from code 920 representative of at least a portion of composite component 410 (FIG. 4), described herein. While executing computer program code, processor 934 can read and/or write data to/from memory 932, storage system 942, I/O device 940 and/or AM printer 906. Bus 938 provides a communication link between each of the components in computer 930, and I/O device 940 can comprise any device that enables a user to interact with computer 940 (e.g., keyboard, pointing device, display, etc.). Computer 930 is only representative of various possible combinations of hardware and software. For example, processor 934 may comprise a single processing unit, or be distributed across one or more processing units in one or more locations, e.g., on a client and server. Similarly, memory 932 and/or storage system 942 may reside at one or more physical locations. Memory 932 and/or storage system 942 can comprise any combination of various types of non-transitory computer readable storage medium including magnetic media, optical media, random access memory (RAM), read only memory (ROM), etc. Computer 930 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 932, storage system 942, etc.) storing code 920 representative of at least a portion of composite component 410 (FIG. 4). As noted, code 920 includes a set of computer-executable instructions defining outer electrode that can be used to physically generate the tip, upon execution of the code by system 900. For example, code 920 may include a precisely defined 3D model of outer electrode and can be generated from any of a large variety of well-known computer aided design (CAD) software systems such as AutoCAD®, TurboCAD®, DesignCAD 3D Max, etc. In this regard, code 920 can take any now known or later developed file format. For example, code 920 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 920 may be translated between different formats, converted into a set of data signals and transmitted, received as a set of data signals and converted to code, stored, etc., as necessary. Code 920 may be an input to system 900 and may come from a part designer, an intellectual property (IP) provider, a design company, the operator or owner of system 900, or from other sources. In any event, AM control system 904 executes code 920, dividing at least a portion of composite component 410 (FIG. 4) into a series of thin slices that it assembles using AM printer 906 in successive layers of liquid, powder, sheet or other material. In the DMLM example, each layer is melted to the exact geometry defined by code 920 and fused to the preceding layer. Subsequently, the portion(s) of composite component 410 (FIG. 4) may be exposed to any variety of finishing processes, e.g., minor machining, sealing, polishing, assembly to other part of the igniter tip, etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method comprising:
identifying a location of potential or actual structural weakness in a body of a turbomachine component, the body including a first material having a first thermal expansion coefficient;
forming a slot in the location of the body, the slot extending at least partially through a wall of the turbomachine component; and
bonding an insert to the body at the slot to form a composite component, the insert including a second material having a second thermal expansion coefficient, the second thermal expansion coefficient differing from the first thermal expansion coefficient by up to approximately ten percent, the second material consisting of a nickel-chrome-molybdenum alloy, wherein after the bonding the insert is configured to reduce the potential or actual structural weakness in the body.

2. The method of claim 1, wherein the first material includes steel.

3. The method of claim 2, wherein the steel includes at least one nickel-chromium superalloy, at least one cobalt-based superalloy or at least one nickel-based superalloy.

4. The method of claim 1, wherein the bonding includes welding or brazing the insert to the body at the slot.

5. The method of claim 4, wherein the bonding is performed at a current of approximately 40-50 Amperes with an arc voltage of approximately 10-15 volts.

6. The method of claim 1, further comprising planarizing an outer surface of the body and the insert proximate the slot after the bonding of the insert to the body.

7. The method of claim 1, wherein the turbomachine component includes a turbomachine blade having: an airfoil with a base and a tip; a platform coupled with the base of the airfoil; and a tip shroud coupled with the tip of the airfoil, and wherein the location is proximate an aft side of a platform at a suction side of the airfoil.

8. The method of claim 1, wherein the identifying includes performing a finite element analysis on a data file representing the turbomachine component to determine the location of the potential or actual structural weakness.

9. The method of claim 1, wherein the identifying includes examining the turbomachine component by a user.

10. The method of claim 1, wherein the identifying includes scanning the turbomachine component using at least one of an optical scanner, an infrared scanner or a fluorescent inspection system.

11. The method of claim 1, wherein the forming of the slot in the body includes cutting the turbomachine component.

12. The method of claim 1, wherein the turbomachine component includes a turbomachine blade having: an airfoil with a base and a tip; a platform coupled with the base of the airfoil; and a tip shroud coupled with the tip of the airfoil, and wherein the location is within the platform or the tip shroud proximate the airfoil.

13. A composite turbomachine component comprising:
a body including:
a wall; and
a slot extending at least partially through the wall,
wherein the body includes a first material having a first thermal expansion coefficient, the first material including at least one of: steel, at least one nickel-chromium superalloy, at least one cobalt-based superalloy or at least one nickel-based superalloy;
an insert substantially filling the slot, the insert including a second material having a second thermal expansion coefficient, the second thermal expansion coefficient differing from the first thermal expansion coefficient by up to approximately ten percent, the second material consisting of a nickel-chromium-molybdenum alloy; and
a weld or braze joint coupling the insert to the body at the slot.

14. The composite turbomachine component of claim 13, wherein the turbomachine component includes a turbomachine blade having: an airfoil with a base and a tip; a platform coupled with the base of the airfoil; and a tip shroud coupled with the tip of the airfoil, and wherein the slot and the insert are located proximate an aft side of a platform at a suction side of the airfoil.

15. The composite turbomachine component of claim 13, wherein the composite turbomachine component includes a turbomachine blade having: an airfoil with a base and a tip; a platform coupled with the base of the airfoil; and a tip shroud coupled with the tip of the airfoil, and wherein a location of the slot and the insert is within the platform or the tip shroud proximate the airfoil.

16. A method comprising:
identifying a location of potential or actual structural weakness in a body of a turbomachine component, the body including a first material having a first thermal expansion coefficient,
wherein the turbomachine component includes a turbomachine blade having: an airfoil with a base and a tip; a platform coupled with the base of the airfoil; and a tip shroud coupled with the tip of the airfoil, and wherein the location is proximate an aft side of a platform at a suction side of the airfoil;
forming a slot in the location of the body, the slot extending at least partially through a wall of the turbomachine component;
bonding an insert to the body at the slot to form a composite component, the insert including a second material having a second thermal expansion coefficient, the second thermal expansion coefficient differing from the first thermal expansion coefficient by up to approximately ten percent, the second material consisting of a nickel-chrome-molybdenum alloy, wherein after the bonding the insert is configured to reduce the potential or actual structural weakness in the body;
planarizing an outer surface of the body and the insert proximate the slot after the bonding of the insert to the body.

17. The method of claim 16, wherein the first material includes steel, wherein the steel includes at least one nickel-chromium superalloy, at least one cobalt-based superalloy or at least one nickel-based superalloy, wherein the bonding includes welding or brazing the insert to the body at the slot, wherein the bonding is performed at a current of approximately 40-50 Amperes with an arc voltage of approximately 10-15 volts.

18. The method of claim 16, wherein the identifying includes performing a finite element analysis on a data file representing the turbomachine component to determine the location of the potential or actual structural weakness.

19. The method of claim 16, wherein the identifying includes examining the turbomachine component by a user.

20. The method of claim 16, wherein the identifying includes scanning the turbomachine component using at least one of an optical scanner, an infrared scanner or a fluorescent inspection system, wherein the forming of the slot in the body includes cutting the turbomachine component.
